(19) United States
(12) Patent Application Publication
(10) Pub. No.: US 2024/0330331 A1
(43) Pub. Date: Oct. 3, 2024

(54) TRANSFORMING TEXT FORMAT TO TREE STRUCTURE FORMAT

(71) Applicant: International Business Machines Corporation, Armonk, NY (US)

(72) Inventors: Yuan YUAN, Beijing (CN); Xing WEN, Beijing (CN); Xiao Zhen ZHU, Beijing (CN); Xiao Ming LIU, Beijing (CN); Shao Fei LI, Beijing (CN); Ming DONG, Beijing (CN); Shou Hua WANG, Beijing (CN)

(21) Appl. No.: 18/190,413

(22) Filed: Mar. 27, 2023

(51) Int. Cl. G06F 16/31

(52) U.S. Cl. CPC G06F 16/322

(57) ABSTRACT

Embodiments of the present disclosure provide systems and methods for transforming a text file with an existing syntax format to a syntax tree structure with a syntax convention extension based on defined field types and field characteristics. Embodiments of the present disclosure transform existing syntax knowledge to an extended convention syntax knowledge, creating the syntax tree structure with the syntax convention extension, to provide automated support for different applications and programs, and enabling programmatic querying, override and other use functions.

### BACKGROUND

The present invention relates to the digital data processing field, and more specifically, to systems and methods for transforming syntax format of text files to a syntax tree structure with a syntax convention extension to transform existing syntax knowledge to an extended syntax convention knowledge, supporting use by multiple applications or programs.

Text files, such as system command files, security command files, and parameter library text files (e.g., text files used define critical control parameters for multiple operating system functions) are often used for various programs and use functions. Each text file can include its own syntax format or a unique syntax format. Text files include many different types of fields where each type of field can require different formats and information. A common syntax convention is not available for syntax formats of the different text files. As a result, no common programmatic technique or automated method exists to support modeling, parsing, or validating different fields of text files. For example, querying by variable name and value from actual content of some text parameter files is not possible because a variable name or a defined relationship between a keyword and value are not available in some existing text files. Managing existing syntax formats can require significant user knowledge, repeated manual efforts, and may be error prone.

### SUMMARY

Embodiments of the present disclosure provide systems and methods for transforming a text file with an existing syntax format to a syntax tree structure with a syntax convention extension. Embodiments of the present disclosure transform existing syntax knowledge to an extended convention syntax knowledge, creating the syntax tree structure with the syntax convention extension, to provide automated support for different applications and programs, and enabling programmatic querying, override and other use functions.

A non-limiting disclosed method comprises receiving a set of text files, where each text file has a respective syntax format to be used to create a syntax tree structure with a syntax convention extension. The system defines a plurality of field types and field characteristics for e syntax information, to enable the syntax convention extension to be validated. The system transforms the text files with the respective syntax format based on the defined field types and field characteristics to generate the syntax tree structure with the syntax format extension. The system maps input content of the text files to the syntax tree structure to generate a syntax field-value content tree structure. The system validates the syntax convention extension based on the syntax field-value content tree structure.

Other disclosed embodiments include a computer system and computer program product for transforming text files with unique syntax format to a syntax tree structure, implementing features of the above-disclosed methods.

### BRIEF DESCRIPTION OF THE DRAWINGS

FIG. 1 is a block diagram of an example computer environment for use in conjunction with one or more disclosed embodiments for transforming syntax format of text files to a syntax tree structure with a syntax convention extension;

FIG. 2 is a block diagram of an example system for transforming syntax format of text files to a syntax tree structure with a syntax convention extension of one or more disclosed embodiments;

FIG. 3A is a flow chart of example operations of a method for implementing a syntax tree structure with a syntax convention extension of one or more disclosed embodiments;

FIGS. 3B and 3C together illustrate an example syntax convention extension of one or more disclosed embodiments;

FIG. 4A illustrates example syntax recognition methods of text syntax format to a syntax tree structure of one or more disclosed embodiments;

FIG. 4B illustrate example syntax content matching methods of actual content of text syntax format to a syntax content tree structure of one or more disclosed embodiments;

FIG. 5A is a flow chart of example operations of a method for transforming a text file with syntax format to a syntax tree structure with a syntax format extension of one or more disclosed embodiments;

FIG. 5B illustrates an example partial syntax tree structure with a syntax format extension of one or more disclosed embodiments;

FIG. 6A illustrates operations of an example method for matching actual content of an input text file to a syntax tree structure with a syntax format extension and generating a syntax field-value content tree structure of one or more disclosed embodiments;

FIG. 6B illustrates an example of a syntax field-value content tree structure of one or more disclosed embodiments;

FIG. 7A illustrates an example method using types of fields as the basic information carrier to query option values of a syntax field-value content tree structure of one or more disclosed embodiments;

FIG. 7B illustrates an example syntax field-value content tree structure of one or more disclosed embodiments;

FIG. 8 illustrates an example method for implementing override functions of one or more disclosed embodiments; and

FIG. 9 is a flow chart of a method for transforming a text file with an existing syntax format to a syntax tree structure with a syntax convention extension of one or more disclosed embodiments.

### DETAILED DESCRIPTION

Embodiments of the disclosure transform a text file with an existing syntax format to a syntax tree structure with a syntax convention extension. The disclosed embodiments transform syntax knowledge of the existing syntax format of available text files to the enhanced syntax format extension (e.g., which avoids the effort to build an initial syntax knowledge dataset). There are many different types of fields that can be analyzed from an existing text file, (e.g., text parameter files and text command files), while each has its own respective syntax format and content and each field type can require different formats and information. However, in these different field types, a common syntax convention is not available for some required content and syntax formats, which limits subsequent modeling and functional use. For example, querying by variable name and value from actual content of some text parameter files is not possible because a variable name or a defined relationship between a keyword and value are not provided in some text parameter files. Embodiments of the present disclosure transform existing syntax knowledge to an extended convention syntax knowledge, creating a syntax tree structure with a syntax convention extension, to provide automated support for different applications and programs, and programmatic use functions, such as querying, override, and other use functions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

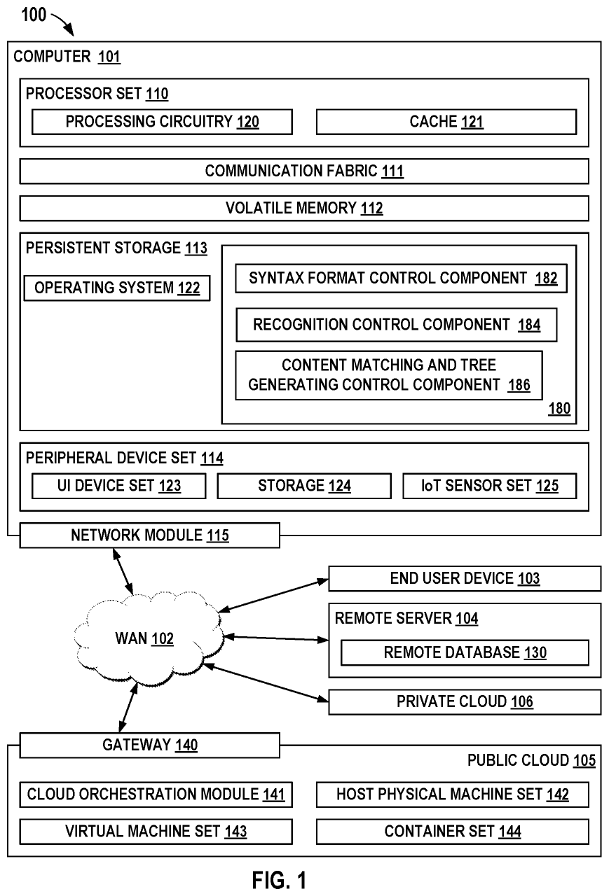

Referring to FIG. 1, a computing environment 100 contains an example of an environment for the execution of at least some of the computer code involved in performing the inventive methods, such as a Syntax Format Control Component 182, a Syntax Recognition and Matching Control Component 184, and a Content Matching and Content Tree Generating Control Component 186, at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments of the disclosure provide systems and methods for transforming text files with syntax format to a syntax tree structure with defined fields to consume syntax knowledge of each text format file, support querying value of every field and enabling override function. The text files include existing text files, for example used to define critical control parameters for predefined operating system functions, system commands, security commands, and the like. An example used for illustrative purposes in the following description is a special file of system settings of an operating system parameter library (Parmlib) of IBM® System Z. Parmlib is a terminology of w/OS, which is the Operating System of IBM System Z (e.g., Mainframe). Parmlib provides a z/OS unique format of text files, which are used to define critical control parameters for z/OS functions. For example, there are at least 100 types of Parmlib files or members, with each Parmlib file used to define control parameters for a specific component or processing function of z/OS. The components or processing functions include some critical functions for z/OS, such as a z/OS initialization process, a z/OS program library, z/OS Unix System Services, and the like. While such Parmlib members are all text format files, each Parmlib member can have a different syntax format. Because all Parmlib members have a pure text format and different syntax formats, there is no common technique capable of validating their syntax, which can result in errors. No common programmatic way exists to parse Parmlib content or mine the control parameters for the whole z/OS of Parmlib. Text based search is generally not possible since there are so many variables and fields in the content of Parmlib files, where each field has specific meaning for a given z/OS function.

In a disclosed embodiment, existing syntax knowledge includes text files of parameter configuration knowledge, system command knowledge, and security command knowledge. Embodiments of the disclosure provide systems and methods for transforming existing text files with syntax format to a tree syntax structure with a syntax convention extension based on defined field types and field characteristics, to consume syntax knowledge of each existing text file, and to support different programs and various system functions, such as validating syntax content, querying field values, and the like. In one embodiment, the syntax tree structure with the syntax convention extension is used to define critical control parameters for predefined operating system functions, system commands, security commands, and the like.

In accordance with one disclosed embodiment, while the syntax format of each text file (e.g., Parmlib member or file) can be different, the respective existing syntax formats can be transformed to a disclosed syntax tree structure with an enhanced syntax convention extension. For example, an existing text file can include multiple statements and content, each statement typically is the first keyword for each line of several fields for a specific system customization, and the content includes actual parameter values.

In disclosed embodiments, existing syntax description and syntax format are used to create a syntax tree structure and a syntax convention extension comprising syntax information including predefined field characteristics and multiple types of fields (e.g., four field types) so that each field in the syntax convention extension can be modeled, validated, and parsed. The disclosed embodiments implement a method to transform horizontal syntax format description to the vertical syntax tree structure with the syntax convention extension and implement a method to map actual content input to the syntax tree structure to generate a syntax field-value content tree structure. The disclosed embodiments implement a method to support querying a given content value of every field of the syntax field-value content tree structure. The disclosed embodiments implement a declarative method to specifically describe and handle override functions for existing text files, such as parameter library z/OS Parmlib files or members.

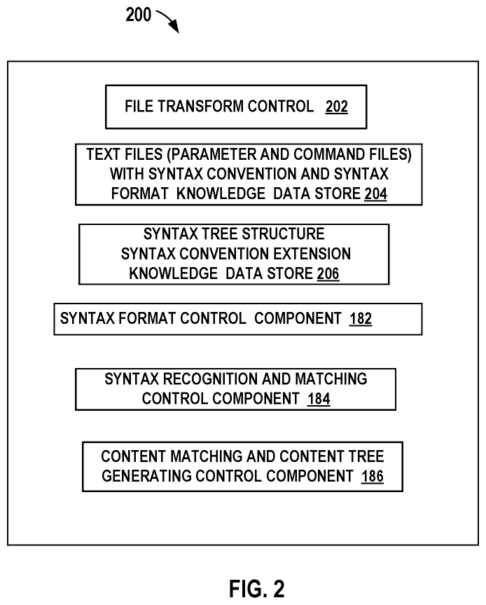

FIG. 2 illustrates an example system 200 for transforming existing text syntax knowledge to an extended syntax knowledge, transforming a text file with an existing syntax format to a syntax tree structure with a syntax convention extension of one or more disclosed embodiments. System 200 can be used in conjunction with the computer 101 and cloud environment of the computing environment 100 of FIG. 1 for implementing the enhanced syntax tree structure with the syntax convention extension of one or more disclosed embodiments.

System 200 transforms text files with existing syntax format knowledge to a syntax tree structure with an extended syntax convention knowledge. The syntax tree structure comprises a syntax convention extension using predefined field types and field characteristics, that enables the respective syntax convention extension fields to be modeled, parsed, and validated. The disclosed syntax tree structure with the syntax convention extension supports applications, programs, and use functions, such as syntax content validation, querying, override and the like. In one disclosed embodiment, system 200 includes a syntax transform control 202, for example used together with the computer 101 to perform operations to implement syntax transforming methods of one or more disclosed embodiments. System 200 includes a knowledge data store 204 of text files (e.g., parameter and command text files), with a respective syntax format of the text files, and a knowledge data store 206 of the syntax tree structures with the syntax convention extension of disclosed embodiments.

In one embodiment, system 200 includes the Syntax Format Control Component 182 to control operations of disclosed methods for transforming text files and syntax format to create a syntax tree structure with syntax convention extension of one or more disclosed embodiments. In one embodiment, system 200 includes the Syntax Recognition and Matching Control Component 184 and the Content Matching and Tree Generating Control Component 186, for example used for generating a syntax tree structure and a syntax field-value content tree structure. System 200 can use the Syntax Format Control Component 182, Syntax Recognition Control Component 184 and the Content Matching and Content Tree Generating Control Component 186 together with the computer 101 for implementing methods of disclosed embodiments.

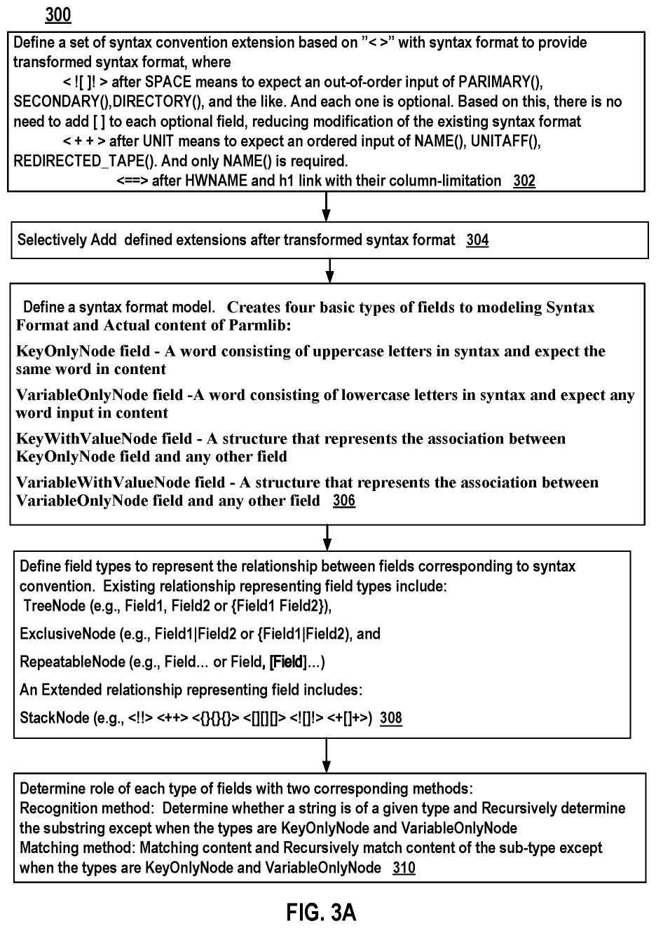

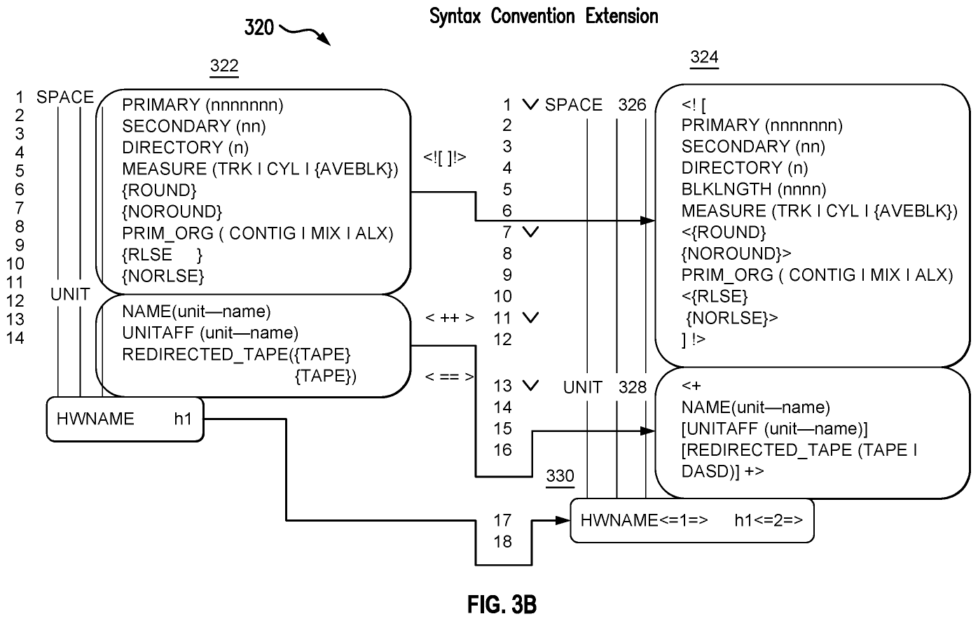

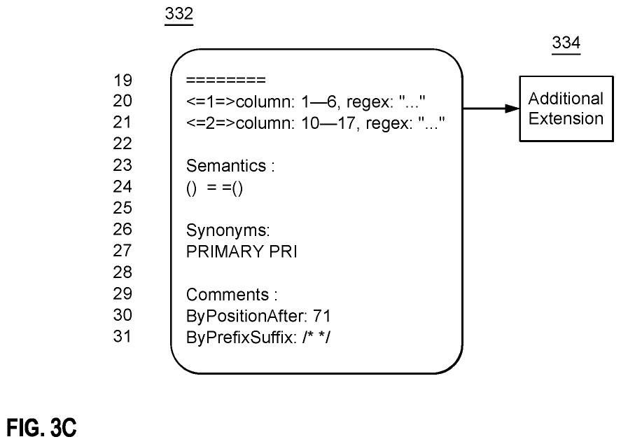

FIG. 3A illustrates example operations of a method 300 for implementing an enhanced syntax tree structure and syntax convention extension of one or more disclosed embodiments. For example, method 300 can be implemented by system 200 in conjunction with the computer 101 of FIG. 1 with the Syntax Format Control Component 182, Syntax Recognition and Matching Control Component 184, and a Content Matching and Tree Generating Control Component 186.

As indicated at block 302 in FIG. 3A, system 200 adds a set of syntax convention extension for predefined field characteristics based on a defined sequence of selected characters or symbols, such as “< >” in syntax format of the syntax convention extension, as shown. In one embodiment as illustrated in FIGS. 3B and 3C, the set of syntax convention extension includes a selected character sequence of <![ ]!> (e.g., meaning an order of fields does not matter). As shown with SPACE 324. <![ ]!> indicates to expect an out-of-order input of PARIMARY( ) SECONDARY( ) DIRECTORY( ) and that each input is optional. Based on the syntax convention extension <![ ]!>, there is no need to add [ ] to each optional field, reducing the needed modification of the existing syntax format of text files. The syntax convention extension includes a selected character sequence of <++> shown with UNIT 328 that indicates to expect an ordered input of NAME( ) UNITAFF( ) REDIRECTED_TAPE( ) and only NAME( ) is required. The syntax convention extension includes <==> with HWNAME 330 and h1 link indicates a column number or column limitation of HWNAME and h1 link, such as 1 and 2 as shown.

Referring also to FIGS. 3B and 3C, an illustrated example syntax convention extension 320 includes the respective defined character sequence of the syntax convention extension of <![ ]!>, <++>, and <==> of one or more disclosed embodiments. In FIG. 3B, an existing syntax format 322 is shown on the left side and a corresponding example syntax convention extension 324 is shown on the right side. The illustrated syntax convention extension 324 includes the defined character sequence of <![ ]!> shown after SPACE 326; the defined character sequence of <++> shown after UNIT 328; and the defined character sequence of <==> shown after HWNAME 330.

It should be understood that the disclosed embodiments are not limited to examples provided, such as example text files and example syntax formats. The disclosed embodiments can be implemented with various text files and syntax format, and are not limited by the described examples. For example, the example syntax convention extension 320 in FIG. 3A and the defined character sequence of the syntax convention extensions illustrated at block 302 in FIG. 3A, are only provided only for illustrative purposes and should not be considered to limit the disclosed embodiments.

At block 304, system 200 selectively adds other additional extensions 332 and 334 of the transformed syntax format of the syntax convention extension. For example, in addition to the predefined field characteristics and four types of fields of the syntax convention extension, system 200 can provide additional syntax settings for library elements of text files, such as Parmlib files. In disclosed embodiments as illustrated at blocks 332 and 334 in FIG. 3C, such additional syntax settings include a separate line (e.g., >=3 dash characters, such as, ———) to distinguish different sections of the syntax file. Additional syntax settings include a “Semantics” definition block to define which semantic characters in the same group should be handled in same way (e.g., these characters in same group should be written in one line and separated by space, and characters in different groups should be written in different lines). A “Synonyms” definition block can be used to define what words in the same group should be handled in same way (e.g., these words in same group should be written in one line and separated by space, and words in different groups should be written in different lines. The enhanced syntax settings include a “Comments” definition block to define what approach is used by the Parmlib member to indicate comments (for example, whether it is started with a special prefix or from a specific column). Additional definition blocks could be defined with this rule, (e.g., a “Meta” definition block to define version information for a version control in a given syntax file).

At block 306, system 200 can create a syntax format model with multiple types of fields, such as four basic types of fields for modeling syntax format and actual content of existing syntax format, such as existing Parmlib files, to the syntax convention extension of disclosed embodiments.

In one embodiment, the four types of fields include a KeyOnlyNode field, which comprises a word consisting of uppercase letters in syntax to expect the same keyword in content, such as “KEY”. Another VariableOnlyNode field is word consisting of lowercase letters in syntax to expect any word input in content, such as “var”. Another KeyWithValueNode field is a structure that represents the association between KeyOnlyNode field and any other field, such as “KEY(value)”. Another VariableWith ValueNode field is a structure that represents the association between VariableOnlyNode field and any other field, such as “var(value)”.

In one embodiment at block 308, system 200 further defines field types to represent the relationship between syntax fields corresponding to syntax convention. Such relationship representing field types include TreeNode (e.g., Field1, Field2 or {Field1 Field2}), ExclusiveNode (e.g., Field1|Field2 or {Field1|Field2), and RepeatableNode (e.g., Field . . . or Field,Field] . . . ). Another Extended relationship representing field includes StackNode (e.g., <!!> <++> <{ }{ }{ }> <][ ][ ]> <![ ]!> <+[ ]+>).

At block 310, system 200 determines a role of each field type, where each field type has two corresponding methods including a recognition method and a matching method. The recognition method can determine whether a string is a given type, and recursively determines the substring type except when the types are KeyOnlyNode and VariableOnlyNode. The matching method can identify matching content and recursively match the sub-type content except when the types are KeyOnlyNode and VariableOnlyNode. For example, system 200 may use the role of types of fields in subsequent processing phases.

In disclosed embodiments, system 200 uses syntax recognition methods received strings and substrings of text syntax format to determine for the syntax types corresponding field types of the syntax convention extension, for example to generate a node of the syntax tree structure. In disclosed embodiments, system 200 uses content matching methods to match the actual content of text syntax format to determine a matching node of the syntax tree and generate a node of a content field-value based tree structure through the syntax tree matching node.

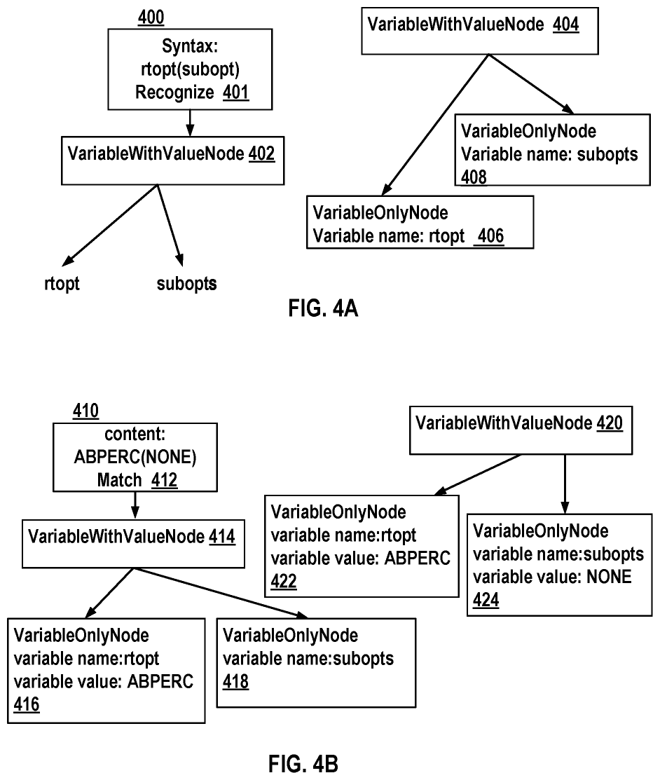

FIGS. 4A and 4B respectively illustrates example syntax recognition methods 400 and example content matching methods 410 of disclosed embodiments. Syntax recognition methods 400 begins at block 401 in FIG. 4A with an input Syntax: rtopt(subopt). At block 402 Variable With ValueNode, system 200 can recognize a string of text syntax format is a given field type, such as with a variable name: rtopt or subopts. System 200 processes the VariableWith ValueNode field at block 404 that can represent an association between a VariableOnlyNode field and any other field, (e.g., to recognize a string is a given field type with a variable name: rtopt or subopts). As shown at block 406, system 200 recognizes a VariableOnlyNode of variable_name: rtopt. Alternatively at block 408, system 200 recognizes a VariableOnlyNode of variable_name: subopts.

In FIG. 4B, the example content matching method 410 begin with input content: ABPERC(NONE) to match at block 412. At VariableWith ValueNode block 414, system 200 can match content of a VariableOnlyNode field and any other field, such as a VariableOnlyNode variable_name: rtopt and variable_value: ABPERC at block 416; or a VariableOnlyNode variable_name: subopts at block 418. At VariableWith ValueNode block 420, system 200 can match content of a VariableOnlyNode variable_name: rtopt and variable_value: ABPERC at block 422; or a VariableOnlyNode variable_name: subopts and variable value: NONE at block 424.

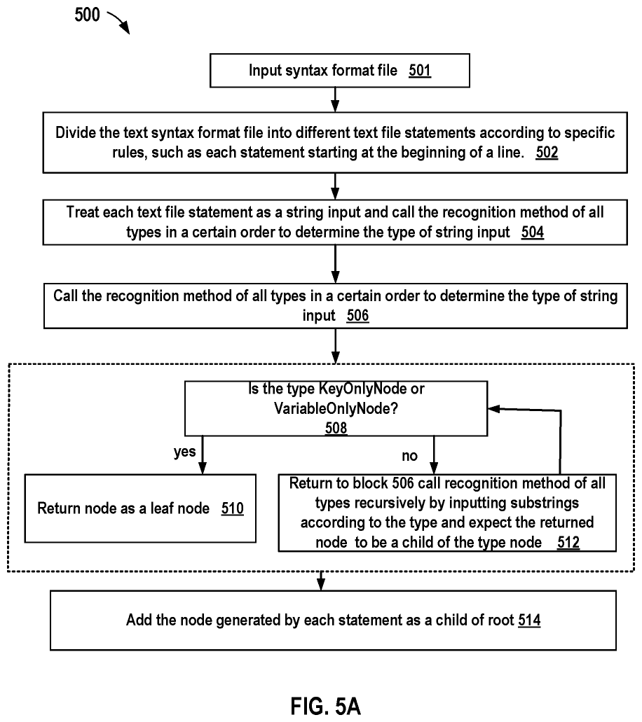

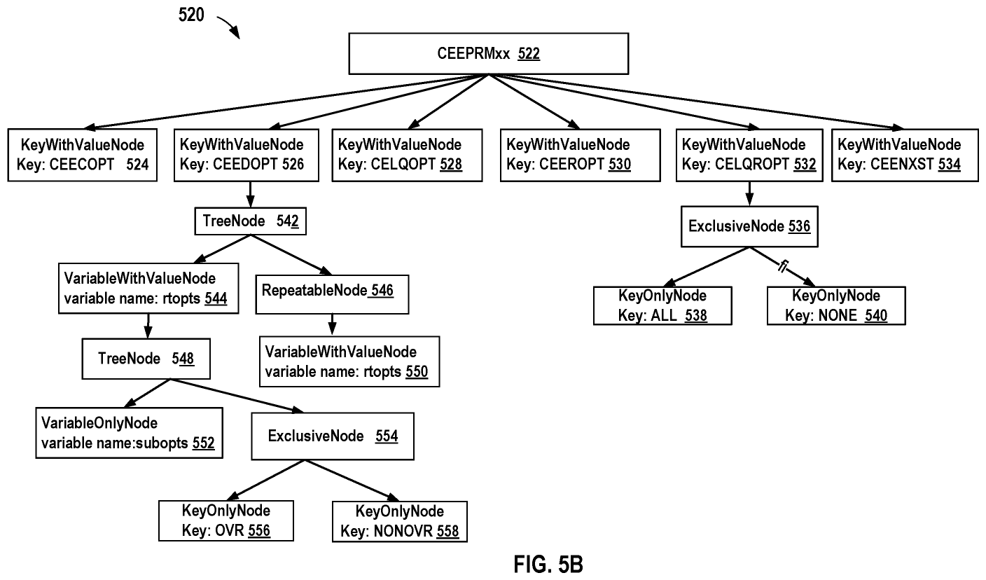

Referring to FIGS. 5A and 5B, example operations for transforming text syntax format to syntax tree and an illustrative syntax tree structure are provided. FIG. 5A illustrates an example method 500 for transforming a pure text syntax format to a syntax tree structure of disclosed embodiments, starting with an input of a syntax format file for existing text file at block 501. FIG. 5B illustrates an example partial syntax tree structure 520 of disclosed embodiments for the syntax format of a text file CEEPRMxx (e.g., text file name shown at node 522).

Examples of given text files and statements are described only for illustrative purposes, it should be understood that the disclosed embodiments are not limited to details of such examples.

An example input at block 501 can be represented by a syntax format file including multiple statements, such as the example following statements

CEECOPT(rtopt=((subopts), {OVR|NOVR}) [, rtopt==((subopts),
{OVR|NOVR})]....
CEEDOPT(rtopt=((subopts), {OVR|NOVR}) [, rtopt==((subopts),
{OVR|NOVR})]....
CELQOPT(rtopt=((subopts), {OVR|NOVR}) [, rtopt==((subopts),
{OVR|NOVR})]....
CEEROPT(ALL|COMPAT)
CELQROPT(ALL|NONE)
CEENXSTG(OFF|ON)

In FIG. 5B, the illustrated respective KeyWith ValueNodes represent the example statements of the input syntax format file for the input file CEEPRMxx, each statement includes a respective Key. As shown, the KeyWith ValueNodes include KeyWith ValueNode Key::CEECOPT 524, KeyWith ValueNode Key::CEEDCOPT 526, KeyWith ValueNode Key: CELQOPT 528, KeyWith ValueNode Key: CEEROPT 530, KeyWith ValueNode Key: CELQROPT 532, and KeyWith ValueNode Key: CEENXST 534.

At block 502, system 200 divides the syntax format file into different statements (e.g., above example listed statements) according to specific rules, such as each statement starting at the beginning of a line. At block 504, system 200 treats each statement as a string input to a recognition method loop starting at block 506. At block 506, system 200 calls the recognition method of all types in a certain order to determine the type of string input.

For example consider the following example statements, such as: CEEDOPT(rtopt=((subopts), {OVR1NOVR}) [, rtopt==((subopts), {OVR1NOVR})] . . . . The call recognition method loop starting at block 508 can be represented by:

KeyWithvalueNode:
CEEDOPT(rtopt=((subopts), {OVR|NOVR}) [, rtopt==((subopts), {OVRlNOVR})]....
TreeNode:
rtopt=((subopts),{OVR|NONOVR})[,rtopt=((subopts),{OVR|NONOVR})]...
VariableWithValueNode:
rtopt=((subopts),{OVR|NONOVR})
TreeNode:
(subopts),{OVR|NONOVR}
VariableOnlyNode:
Subopts

At decision block 508, system 200 checks whether the string input type is a KeyOnlyNode or a VariableOnlyNode. At block 510, when system 200 determined at block 508 that the type is KeyOnlyNode or VariableOnlyNode, system 200 returns the node as a leaf node. At block 512, when determined at block 508 that the type is not KeyOnlyNode or VariableOnlyNode, system 200 returns to block 506 calling the recognition method of all types, recursively inputting substrings according to the type, and expect the returned node to be a child of the type node. At block 514, system 200 adds the node generated by each statement as a child of a root in the generated syntax tree structure.

In FIG. 5B, the illustrated partial syntax tree structure includes an example subtree of an ExclusiveNode 536 with a KeyOnlyNode with Key: ALL 538 and KeyOnlyNode with Key: NONE 540 extending from the KeyWith ValueNodes Key: CELQROPT 532. The illustrated subtree of syntax tree nodes ExclusiveNode 536, KeyOnlyNode with Key: ALL 538 and KeyOnlyNode with Key: NONE 540 can represent to the above example statement of statement CELQROPT.

Other illustrated subtrees extend from the KeyWith ValueNodes Key: CEEDOPT 528 includes a TreeNode 542 to a Variable With ValueNode with variable name: rtops 544 and a RepeatableNode 546 to a Variable With ValueNode with variable name: rtops 550. The Variable With ValueNode with variable name: rtops 544 extends to a TreeNode 548 that extends to a VariableOnlyNode with variable name: rtops 552 and an ExclusiveNode 554. As shown, the ExclusiveNode 554 extends to a KeyOnlyNode with key: OVR 556 and a KeyOnlyNode with key: NONOVR 558. The illustrated subtrees extending from the KeyWith ValueNodes Key: CEEDOPT 528 can represent the above example statement of CEEDOPT(rtopt=((subopts), {OVR1NOVR}) [, rtopt==((subopts), {OVR1NOVR})].

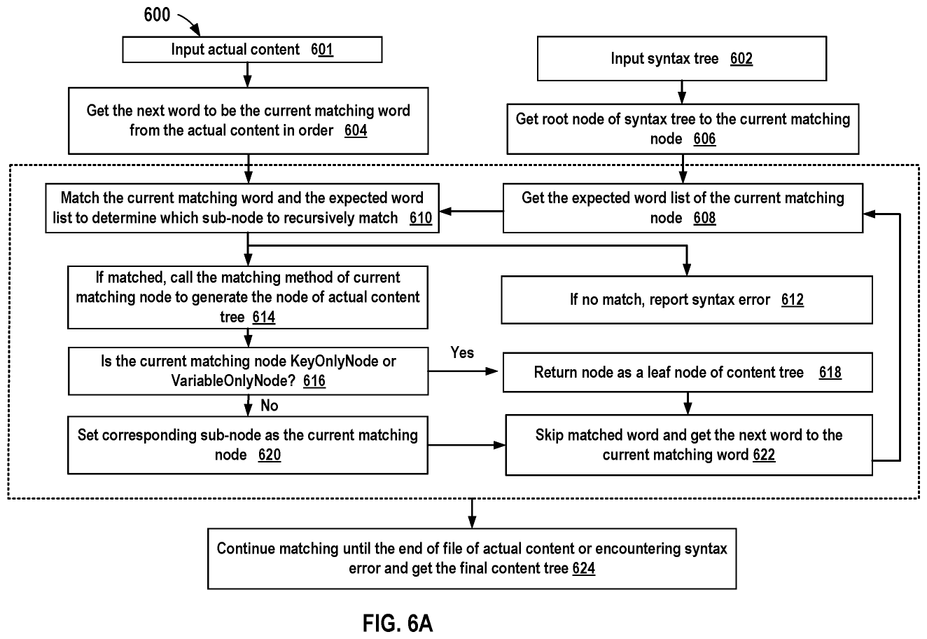

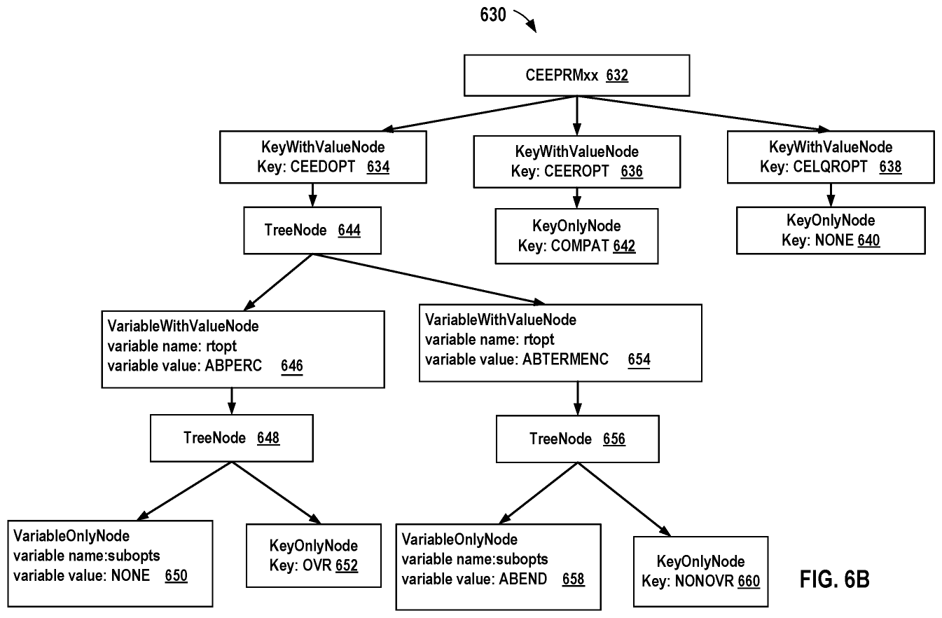

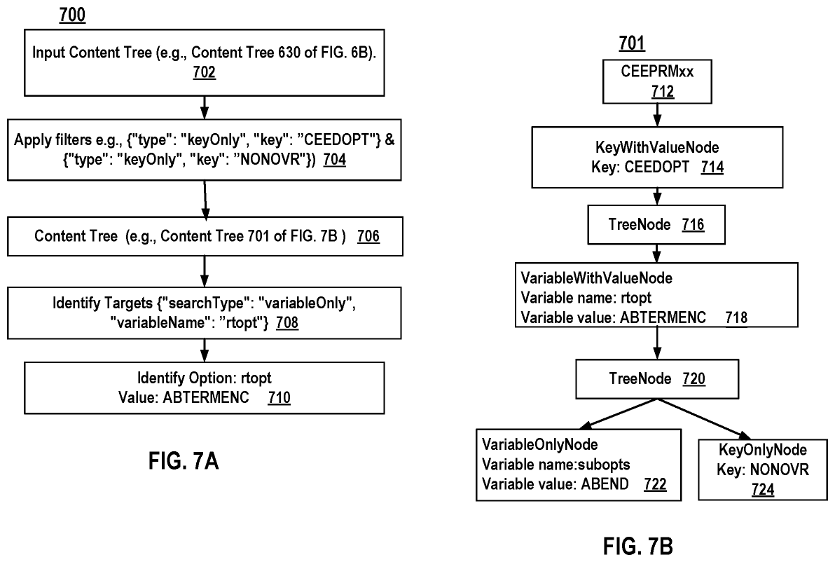

FIG. 6A illustrates an example method 600 for mapping actual content of a syntax format file to syntax tree structure to generate a syntax content tree of one or more disclosed embodiments. FIG. 6B illustrates an example syntax content tree 630 of disclosed embodiments. In a disclosed embodiment, system 200 can map each statement word by word of a syntax content input to match a syntax tree node of a given syntax tree structure and generate a field-value based content tree structure, through matching methods of disclosed embodiments.

In FIG. 6B, an example syntax field-value content tree structure 630 is provided for the example text file CEEPRMxx (e.g., text file name shown at node 632), which includes example KeyWith ValueNode with Key: CEEDOPT 634, KeyWith ValueNode with Key: CEEROPT 636 and KeyWith ValueNode with Key: CELQROPT 638 representing respective above example Parmlib statements. As shown, an example KeyOnlyNode Key: NONE 640 extends fron KeyWith ValueNode with Key: CELQROPT 638, and an example KeyOnlyNode Key: COMPAT 646 extends from KeyWith ValueNode with Key: CEEROPT 636.

In FIG. 6B, the KeyWith ValueNode with Key: CEEDOPT 634 and illustrated subtree nodes can represent the above example statement of CEEDOPT(rtopt=((subopts), {OVR1NOVR}) [, rtopt=((subopts), {OVR1NOVR})] corresponding in part to the illustrated partial syntax tree structure 520 of FIG. 5B. In the example syntax field-value content tree structure 630, content values are shown in multiple subtree nodes extending from the KeyWith ValueNode with Key: CEEDOPT 634. As illustrated, the subtree nodes with content value include a VariableWith ValueNode variable name rtopt with variable value ABPERC 646 and a Variable With ValueNode variable name rtopt with variable value ABTERMENIC 654. Additional illustrated nodes with content value include a VariableOnlyNode variable name subopts with variable value: NONE 640 and a VariableOnlyNode variable name subopts with variable value: ABEND 658.

In FIG. 6A, at block 601 system 200 receives an input of actual content of a syntax file and at block 602 system 200 receives an input of the syntax tree structure, for example used to generate an syntax field-value content tree structure with the actual content input, such as illustrated in FIG. 6B for the example text file CEEPRMxx. At block 604, system 200 gets a next word to be the current matching word of the actual content input in an order of words included in respective defined fields of text file statements. At block 606, system 200 gets a root node of the syntax tree to be the current matching node. At block 608, system 200 gets an expected word list of the current matching node. At block 610, system 200 can match the current matching word and the expected word list to determine which sub-node to recursively match. If no match is found at block 610, system 200 reports a syntax error at block 612.

At block 614 for the identified match, system 200 calls the matching method of the current matching node to generate the node with actual content for the syntax field-value content tree structure. At decision block 616, system 200 checks whether the current matching node is a KeyOnlyNode or a VariableOnlyNode. At block 618, when system 200 determined at block 616 that the current matching node is a KeyOnlyNode or VariableOnlyNode, system 200 returns the node as a leaf node of the content tree. At block 620, when determined at block 616 that the current matching node is not a KeyOnlyNode or VariableOnlyNode, system 200 sets the corresponding sub-node as the current matching node. At block 622, system 200 skips the matched word and get the next word to be the current matching word, and system 200 returns to block 608 and continues processing. As indicated at block 624, system 200 continues matching until reaching the end-of-file of actual content of the given text syntax form file or encountering a syntax error and provides the final syntax field-value content tree structure generated with the actual content input.

FIGS. 7A and 7B respectively illustrate an example query method 700 and an example syntax field-value content tree structure 701 using types of fields as the basic information carrier to query an option value of Parmlib statements one or more disclosed embodiments. System 200 can implement the disclosed embodiments of the syntax tree structure with the syntax convention extension for example using a common data-interchange format, such as a JavaScript Object Notation (JSON). JSON is an open standard file format and data interchange format that uses human-readable text or plain text written in JavaScript object notation to store and transmit data objects including data in the form of key-value pairs and arrays, where keys and values are separated by colon, and each entry (key/value pair) is separated by comma.

For the defined type fields comprising the syntax convention extension of disclosed embodiments, a Filter example and Target example of a JSON form can be represented as follows:

```
  KeyOnlyNode field (word in uppercase letters in syntax to expect the
same word in content, such as “KEY”)
Filter example: {″type″: ″keyOnly″, ″key″:″″}
Target example: {″searchType″: ″keyOnly″, ″key″:″″}
  VariableOnlyNode field (word in lowercase letters in syntax to expect
any word input in content, such as “var”)
Filter example: {″type″: ″variableOnly″, ″variableName″:″″,
″variableValue″:″″}
Target example: {″searchType″: ″variableOnly″, ″variableName″:″″}
  KeyWithValueNode field (structure representing association between KeyOnlyNode
field and any other field, such as “KEY(value)”)
Filter example: {″type″: ″keyValue″, ″key″:″″, ″value″:″″}
Target example: {″searchType″: ″keyValue″, ″key″:″″}
  VariableWithValueNode field (structure representing the association between
VariableOnlyNode field and any other field, such as “var(value)”)
Filter example: {″type″: ″variableValue″, ″variableName″:″″, ″variableValue″:″″, ″value″:″″}
Target example: {″searchType″: ″variableValue″, ″variableName″:″″, ″variableValue″:″″}
```

As indicated at block 702, system 200 receives an input Content Tree, (e.g., syntax content tree 630 of FIG. 6B). As indicated at block 704, system 200 applies filters, such as shown {“type”: “keyOnly”, “key”: “CEEDOPT”}.&{“type”: “keyOnly”, “key”: “NONOVR”. At block 706, system 200 can identify query option value on the content tree, for example, blocks 634, 636 of Content Tree 630. At block 708, system 200 can identify targets, for example, {“searchType”: “variableOnly”, “variableName”: “rtopt” }. At block 710, system 200 can identify an option value, for example, Option: rtopt Value: ABTERMENC, as shown.

Referring to FIG. 7B, the illustrated example syntax content tree 701 includes the example text file CEEPRMxx (e.g., text file name shown at node 712), and the example KeyWith ValueNode with Key: CEEDOPT 714. Syntax content tree 701 includes subtree nodes of a TreeNode 716, a VariableWithValueNode variable name rtopt with variable value ABTERMENIC 718, a TreeNode 720, a VariableOnlyNode variable name subopts with variable value: ABEND 722, and a KeyOnlyNode Key: NONOVR 660. As shown in the example syntax field-value content tree structure 701, content values are shown in the subtree nodes including the VariableWith ValueNode variable name rtopt with variable value ABTERMENC 718 and the VariableOnlyNode variable name subopts with variable value ABEND 722.

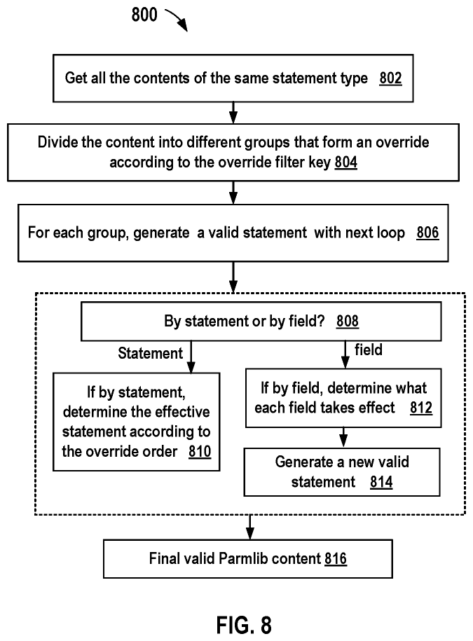

FIG. 8 illustrates an example method 800 using types of fields as the basic information carrier to implement an override function of one or more disclosed embodiments. For example, in one or more Parmlib files, a type of statement can appear multiple times, override settings are provided to determine which Parmlib statement or member content would be valid when more than one of the same members is specified. In a disclosed embodiment, override settings are provided to determine which Parmlib statement or member content would be valid when more than one of the same members is specified. In a disclosed embodiment, override settings use defined Suffix/Content order to handle override order between member contents or statements. For example, the defined Suffix/Content order includes a First effect: indicating that it takes effect when it first appears and ignore what appears later; a Last effect: indicating that it takes effect when it last appears and ignore what appears before; and Concatenation: indicating that all occurrences take effect and form a group. In a disclosed embodiment, override settings include an Override scope, such as by statement that indicates that each of the statements that form an override relationship is inseparable and the valid one must be one of the statements. Another Override scope, such as by field indicates that each field of the statement is the minimal override unit and the valid one is generated from all statements that form override relationship. In a disclosed embodiment, override settings include Override key filters that determine which statements form override relationships by key filters and an override is formed when all key filters are satisfied. In a disclosed embodiment, a flag is created to make “key&flag” equivalent to “key (key no exist).”

At block 802, system 200 gets all the contents of the same statement type. For example, four original input of a Parmlib statement can include the following:

1 :SYSDEF HWNAME(H1) LPARNAME(L1) SYSNAME(A)
SYSCLONE(X) SYMDEF(&sys1=ABC)
2: SYSDEF HWNAME(H1) LPARNAME(L1) SYSNAME(B)
SYSCLONE(Y) SYMDEF(&sys1=BCD)
3: SYSDEF HWNAME(H1) LPARNAME(L2) SYSNAME(B)
SYSCLONE(Y) SYMDEF(&sys1=EFG)
4: SYSDEF HWNAME(H1) LPARNAME(L2) SYSNAME(A)
SYSCLONE(X) SYMDEF(&sys1=FGH)

At block 804, system 200 divides the content into different groups that form an override according to the overrider filter key, such as a first group including statements 1 and 2, and a second group including statements 3 and 4. As indicated at block 806, for each of the groups, a valid state is generated with the next loop starting at block 808. At decision block 808, system 200 determines whether to generate the valid statement by statement or by field. At block 810, if by statement, system 200 determines the effective statement according to override order. Alternatively at block 812, if by field, system 200 determines what each field takes effect. For example at block 812, system 200 can determine the effect of each field as described above according to the Override scope by field indicates that each field of the statement is the minimal override unit and the valid one is generated from all statements that form the override relationship. At block 814, a new valid statement is generated. At block 816, system 200 can determine the final valid Parmlib content using the effective statement of block 8′0 or the generated new statement at block 814.

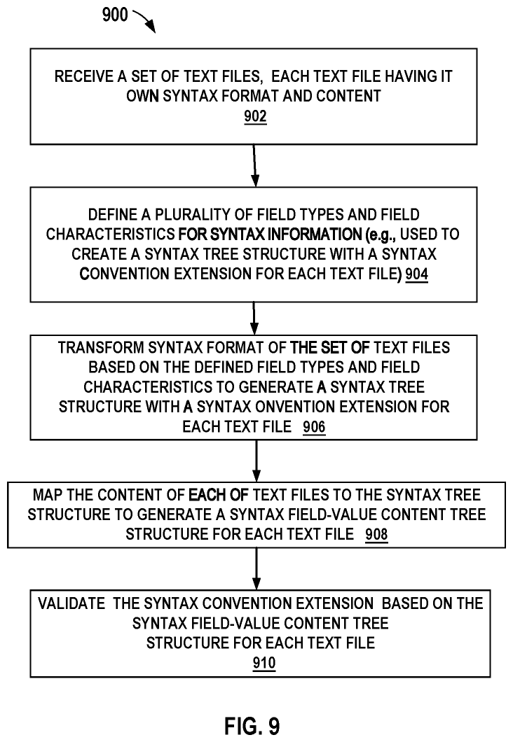

FIG. 9 illustrates a method 900 for transforming a text file with an existing syntax format to a syntax tree structure with a syntax convention extension of one or more disclosed embodiments. At block 902, system 200 receives a set of text files, each text file having a syntax format and content. For example, the received text files comprise text parameter files, text command files, text security command files, or combinations thereof. For example, FIG. 3B provides one example syntax format 322 and corresponding example syntax convention extension 324. Method 500 of FIG. 5A and the example syntax tree structure 520 of FIG. 5B provide other text file examples.

At block 904, system 200 defines a plurality of field types and field characteristics for syntax information, (e.g., used to create the syntax tree structure with the syntax convention extension for each text file). For example, FIGS. 3A, 3B and 3C provide illustrative examples of field types and field characteristics that may be defined at block 904. At block 906, system 200 transforms the syntax formats of the set of text files based on the defined field types and field characteristics to create the syntax tree structure with the syntax convention extension for each text file, such as illustrated in FIGS. 5A and 5B. At block 908, system 200 maps the content of respective text files to the syntax tree structure for each text file to generate a syntax field-value content tree structure. Method 600 of FIG. 6A and the example syntax field-value content tree structure 630 of FIG. 6B provide illustrative examples of operations to generate a syntax field-value content tree structure of disclosed embodiments. At block 910, system 200 validates the syntax convention extension based on the syntax field-value content tree structure for each text file. Method 700 of FIG. 7A and the example syntax field-value content tree structure 701 of FIG. 7B, and method 800 of FIG. 8 provide illustrative example operations to validate the syntax convention extension for each text file of disclosed embodiments.

While the foregoing is directed to embodiments of the present invention, other and further embodiments of the invention may be devised without departing from the basic scope thereof, and the scope thereof is determined by the claims that follow.

What is claimed is:

1. A method comprising:
receiving a set of text files, each text file having a syntax format and content;
defining a plurality of field types and field characteristics for syntax information;
transforming the syntax formats of the set of text files based on the plurality of field types and field characteristics to create a syntax tree structure with a syntax convention extension for each text file;
mapping the content of each of the text files to the syntax tree structure to generate a syntax field-value content tree structure for each text file; and
validating the syntax convention extension for each of the text files based on the syntax field-value content tree structure.

2. The method of claim 1, wherein the received text files comprise at least one of text parameter files, text command files or text security command files.

3. The method of claim 1, wherein the text file content comprises an actual parameter value of the syntax format of a given text file.

4. The method of claim 1, wherein the field characteristics comprise defined character sequences to define selected field characteristics.

5. The method of claim 1, wherein the field characteristics comprise character sequences used to define at least one of an order of fields, an ordered field input, an out of order field input, or a column number limitation.

6. The method of claim 1, wherein the field types are defined for modeling syntax format and actual content of text files.

7. The method of claim 1, wherein the field types define at least one of a keyword, an association between fields, a field role of each field type, a syntax recognition method, or a content matching method.

8. The method of claim 1, wherein the syntax convention extension comprises definition blocks to define comments, semantics, synonyms, library elements of text files of comments, semantics, synonyms, and library elements of text files.

9. The method of claim 1, further comprising providing automated support for multiple applications based on the syntax tree structure with the syntax convention extension for each text file.

10. The method of claim 1, further comprising enabling programmatic querying and override functions based on the syntax field-value content tree structure.

11. A system, comprising:
a processor; and
a memory, wherein the memory includes a computer program product configured to perform operations for transforming text file format to a structure-based format with text syntax knowledge transformed to an extended convention syntax knowledge, the operations comprising:
receiving a set of text files, each text file having a syntax format and content;
defining a plurality of field types and field characteristics for syntax information;
transforming the syntax formats of the set of text files based on the plurality of field types and field characteristics to create a syntax tree structure with a syntax convention extension for each text file;
mapping the content of each of the text files to the syntax tree structure to generate a syntax field-value content tree structure for each text file; and
validating the syntax convention extension for each of the text files based on the syntax field-value content tree structure.

12. The system of claim 11, wherein the text file content comprises an actual parameter value of the syntax format of a given text file.

13. The system of claim 11, wherein the field types are defined for modeling syntax format and actual content of text files.

14. The system of claim 11, wherein the field characteristics comprise character sequences used to define at least one of an order of fields, an ordered field input, an out of order field input, and or a column number limitation.

15. The system of claim 11, further comprising providing automated support for multiple applications based on the syntax tree structure with the syntax convention extension for each text file.

16. A computer program product for transforming text file format to a structure-based format with existing text syntax knowledge transformed to an extended convention syntax knowledge, the computer program product comprising:
a computer-readable storage medium having computer-readable program code embodied therewith, the computer-readable program code executable by one or more computer processors to perform an operation comprising:
receiving a set of text files, each text file having a syntax format and content;
defining a plurality of field types and field characteristics for syntax information;
transforming the syntax formats of the set of text files based on the plurality of field types and field characteristics to create a syntax tree structure with a syntax convention extension for each text file;
mapping the content of each of the text files to the syntax tree structure to generate a syntax field-value content tree structure for each text file; and
validating the syntax convention extension for each of the text files based on the syntax field-value content tree structure.

17. The computer program product of claim 16, wherein the text file content comprises an actual parameter value of the syntax format of a given text file.

18. The computer program product of claim 16, wherein the field types are defined for modeling syntax format and actual content of text files.

19. The computer program product of claim 16, wherein the field characteristics comprise character sequences used to define at least one of an order of fields, an ordered field input, an out of order field input, or a column number limitation.

20. The computer program product of claim 16, further comprising enabling programmatic querying and override functions based on the syntax field-value content tree structure.
